(19) United States
(12) Patent Application Publication
(10) Pub. No.: US 2021/0158453 A1
(43) Pub. Date: May 27, 2021

(54) INCOME PROTECTION TOOLS FOR ATHLETES AND PROFESSIONALS CONTINUOUSLY RISKING BODILY INJURY AND SICKNESS

(71) Applicant: David Brookbank, High Point, NC (US)

(72) Inventor: David Brookbank, High Point, NC (US)

(21) Appl. No.: 17/160,763

(22) Filed: Jan. 28, 2021

Related U.S. Application Data
(63) Continuation of application No. PCT/US2020/014996, filed on Jan. 24, 2020.
(60) Provisional application No. 62/796,216, filed on Jan. 24, 2019.

(51) Int. Cl. G06Q 40/08

(52) U.S. Cl. CPC G06Q 40/08

(57) ABSTRACT

One or more devices that provides a tool, with an associated system and method, that provides calculation and associated comparisons of loss of income insurance policy claims resulting from illness or injury of professional athletes entering the professional athletics arena through a professional sports draft. The tool also provides a similar capability for professional service individuals risking bodily harm during the course of carrying out duties of their respective professions. The system includes a relative valuation of diverse contractual attributes for each professional sport, and the syntheses via multivariant analysis of relative valuations/salary projections for eligible draft candidates in a given year by utilizing a Salary Index for each sport being evaluated. The analysis method can be used for the assessment and comparison for both amateur athletes as well as professional athletes desiring to establish/renew their contract and protect future earnings against loss in the event of a catastrophic disability.

### PRIORITY

This application is a continuation of and claims benefit under 35 USC 120 of PCT/US2020/014996 filed Jan. 24, 2020, which is a PCT International Application filing of U.S. Provisional Application 62/796,216 filed Jan. 24, 2019, the entire contents of which are hereby both incorporated by reference.

### BACKGROUND

Highly skilled athletes as well as individuals that physically risk their lives or at least their livelihood for the benefit of protecting the public safety (police, fire, EMT personnel, etc.) require the ability to protect their income in the event of a catastrophic event that either ends or threatens to end their careers in the sport or public service activity in which they compete and/or serve. For athletes, especially young athletes just beginning their athletic career, at either the amateur or professional level, this need is acute. More specifically, for young males involved in sports, the monetary rewards can provide them with instant financial success and independence due to lucrative professional sports contracts in, for example, football, basketball, baseball and soccer. For young females the athletic earning potential is the highest among foreign professional sports such as basketball. The need to protect their income as participants in activities which can and often do cause injury, is essential. Should they no longer be able to perform, this decision-making issue is one that none of these athletes or their respective legal counsel, athletic/educational organizations, healthcare, or insurance professionals have the skills to even begin to address. Properly providing income protection analysis for these individuals has quickly become a decision-making responsibility that must be addressed by using other than simple comparison techniques, as each “disability” policy from each insurance carrier is different. Each policy includes unique characteristics that greatly influence the eventual financial outcome should an unfortunate catastrophic event occur.

As alluded to above, for amateur athletes entering the professional ranks as well as for public safety providers, the possibility of a catastrophic event that may end their professional careers always exists. The risk of these events normally increases with the frequency of the activity, the age of the professional, and the activities in which they participate. For certain sports, especially male dominated professional sports, athletes in the United States must often participate at the collegiate level in order to become eligible for the professional ranks. This eligibility issue for athletes is less severe in other areas around the globe, such as for professional soccer, cricket, etc., however the need to provide insured income protection if the catastrophic event takes place remains a critical need.

Amateur athletic programs such as college and university sports programs, in particular college football and basketball teams, derive large sums of money per year from various sources, including but not limited to national and regional broadcast, cable networks that televise games, various internet broadcast entities, and local, regional, and national radio networks that broadcast games, provide ticket sales, and concessions at stadiums, as well as licensing fees from collegiate sports branded merchandise. Various organizations oversee athletic programs of many colleges and universities in the United States and throughout the world. One such organization is the National Collegiate Athletic Association (“NCAA”).

Various rules and regulations regarding athletic organizations (e.g., the NCAA) prevent and/or discourage colleges and universities from paying college athletes (aside from scholarships) direct compensation such as a salary or monetary bonus. Normally, while a college athlete is still enrolled in a college or university in the United States and Canada, in order to preserve a student athlete's amateur status, no direct monetary compensation is allowed. The compensation inequity is presumably alleviated for the student-athlete when the athlete is drafted into a professional league and offered a professional contract.

### SUMMARY

One specific example that describes one aspect of the present disclosure, is that for colleges and universities belonging to the NCAA Division I membership, including but not limited to Power 5 or Autonomy 5 conferences (ACC, B10, SEC, BIG-12 and PAC-12, and their member institutions), Conference USA, The American Athletic Conference, Division I Football Independents, the Mid-American Conference, the Mountain West Conference, and the Sun Belt Conference, the issue regarding how to protect their student-athletes' income earning potential has become an issue that the athletic directors and university presidents cannot manage. These institutional employees are searching for immediate answers. As recruiting these athletes is a very competitive ongoing concern, being able to offer education and consultation for these collegiate recruits is another benefit that each college and university wants to provide. The student-athletes need to consider numerous factors regarding how much insurance (disability-type) they should purchase (or in most cases, not purchase). The capacity for a decision-making capability required to consider these factors and predict the financial outcomes are beyond the scope and capability of those internal or external to the university/college employees and other personnel with whom the student-athlete interacts on a daily, weekly, or monthly basis.

Embodiments of the present disclosure describe a tool, system, and method that determines where (which professional team and location) the professional athlete prospect is projected to be drafted based on actuarial evidence, analysis of their potential rookie salary, calculates losses due to injury or illness, and calculates and compares potential insurance policy pay-outs based on other contracts/policies offered to the professional athlete. The system includes the capability to evaluate and calculate the potential losses incurred in income for current (active) collegiate potential draft candidates/prospects and current (active) professional athletes who own or consider owning draft protection and contract protection insurance (Loss of Value insurance policies) within the NFL, NBA, WNBA, NHL, MLS, WSL, and MLB. The disclosure and associated invention does not merely compare insurance products but instead provides a decisional analysis system that utilizes complex calculations to inform, in the form of data and data analysis, so that the individual receives adequate compensation if the catastrophic event occurs.

More specifically the present disclosure and associated invention describes a tool utilizing one or more devices for completion of multiple calculations that determine and compare dynamically changing maximum insurance policy liability payouts, wherein the payouts change in value for one or more contractual compensation(s) for a professional individual and wherein change of value of the payouts is a dynamic threshold value minus a dynamic contract value wherein the dynamic threshold value is utilized by one or more syndicates within one or more insurance companies to determine and ensure that a selected insurance policy covers a loss of payout that is less than the dynamic threshold value but greater than zero after the contract is completed by the professional individual.

Here the professional individual is any one of a group consisting of; an amateur or professional athlete, a fireman, policeman, corporate employee, physician, engineer, construction worker, mail carrier, city or county civil employee, university administrator, athletics director, coach, people who drive or ride in vehicles, boats, aircraft, and sports agent and wherein the contract is considered complete/valid after the contract is signed and dated.

The calculations are performed and displayed via visual auditory, and/or visual/auditory techniques such that the tool resides one or more computers and/or computer platforms selected from a group consisting of: a networked computer system, a networked cloud-based computer system, one or more internet and/or intranet systems, computer laptops, computer pads, computer terminals, smart phones, and wearable computer devices and wherein contractual compensation(s) are provided for one or more professional athlete's contracts. The tool also provides a payout value after an athlete triggers a valid claim via injury, illness, or other disability that impairs an ability of the athlete to perform according to a contract's policy claims and definitions.

The threshold value is a value that triggers a claim based upon analysis of a compensatory contract's policies wherein when contract language is satisfied a value of a contract is less than the threshold value.

The calculations include comparison of threshold values and salary contract guarantees associated with either a position in a draft and/or a contract offer.

Analysis of the calculations provide for a comparison of different policy benefits to determine different payout values for one or more insurance policies.

Analysis of the calculations compare different policy benefit definitions, triggers, and exclusions, in order to ascertain the likelihood of a claim payment.

The calculations include a risk analysis and assign a risk value for each payout based upon policy provisions, definitions, and exclusions.

The calculations compare values from each salary from each athlete that performs in one or more sports to arrive at a largest potential payout among a series of insurance policies.

The calculations provide one or more future projected values for each slot position in a professional athlete draft.

The calculations provide one or more future projected values for various contract offers from a single professional sports team or multiple contract offers from multiple professional sports teams.

The threshold value is a value assigned and specific to an insured professional or professional prospect based upon a number that one or more insurance companies determine is a risk adjusted earnings potential for the professional.

Cover holders utilize actuaries and underwriters to establish threshold values wherein threshold values are at least partially determined based upon specific physical risks and certain projects contract payouts associated with the professional.

Insurance policies are futures contracts with changing dynamic premiums determined via calculations regarding payout based upon predetermined threshold values less a signed contract value and any change in physical ability or health of the professional.

One or more syndicates utilize one or more threshold values to provide values for one or more compensatory contracts.

The underwriters and/or syndicate actuaries determine risks for policies, thresholds, and compensatory contracts.

The cover holders design contract language and provide risk options associated with the contract language to syndicates in order that syndicates can determine a specific degree of risk their investors are willing to ascertain.

The cover holders sell insurance policies and design contract rules that vary among cover holders such that an insurance policy coverage offer and value (amount) is different for each professional and calculations determine how much each insurance policy pays out when one or more insurance policy terms are satisfied.

The cover holders and brokers sell policies to professionals and/or student athletes.

The cover holders and brokers sell policies to professional sports teams and/or collegiate athletic departments.

Loss of compensation value is a payment of a claim calculated as a difference between the threshold value and a signed, completed and/or earned contract value, or the difference between a threshold value and total compensation earned over a given contract period.

For an athlete, as a drop in draft position occurs, composition contract value drops but insurance policy coverage value increases to a maximum amount of stated liability.

The maximum amount of stated liability is a calculated value that is reflected or stated within insurance policies.

The loss of value is also associated with a reduction in draft position.

The loss of value of income to an athlete is calculated as a difference between threshold value and actual signed contract value and can be a loss of a rider value depending on a base disability policy if and only if a calculated difference between a threshold value and a contract value is a positive number.

A final draft position at least partially determines a cost and value of a disability insurance policy based upon accidental injury and/or illness.

A temporary disability of an athlete causes a drop in the draft position and/or compensatory contract value.

Permanent disability is defined as inability for an athlete to continue to play in a professional sport due to injury and/or illness including trauma to a head of an athlete and/or the athlete is disabled to an extent where the athlete is no longer able to perform according to expectations of the compensatory contract.

The compensatory contract protection insurance policy can be and is in this instance linked to a disability policy for the professional.

A final compensatory contract offer is differentiated from a signed compensatory contract offer as both offers are seldom identical.

In another embodiment, a system for evaluating and calculating potential losses incurred in income for current collegiate potential draft candidates/prospects and current professional athletes who own or consider owning draft protection insurance (Loss of Value) within the NFL, NBA, WNBA, NHL, MLS, WSL, and MLB comprising either sequential or non-sequential steps of:

a) selecting a professional sport in which a collegiate athlete participates and utilizing a Contract Salary Index (CSI) to examine ranges of salary expected for each slot value in a corresponding professional related athletics draft;
b) utilizing one or more insurance contracts which insure loss of earnings due to an illness or injury and assigning a threshold value for each contract;
c) selecting a current salary scale for the professional sport;
d) projecting a future value of salary increase for the professional sport and athlete participating in the professional sport;
e) using a Contract Salary Index to compare potential payouts incurred due to an illness or injury preventing the athlete to further participate in a selected sport;
and/or;
f) using the Contract Salary Index to compare potential payouts incurred due to an illness or injury which results in a financial loss due to a drop in draft position and/or valid contract value;

In a further embodiment, it is possible to select multiple Permanent and Total Disability insurance policy Products and Loss of Value insurance riders, calculating a projected loss for each proposed insurance contract, and using projected loss indices to compare each alternative insurance products to determine payout levels for each insurance contract.

Here, the Threshold Value or Attachment Point is assigned by each insurance provider.

The Contract Salary Index is equal to a current salary for each draft slot position for each professional sport.

In addition, the Contract Salary Index contains an identifiable number which corresponds with a value for each draft slot based on historical professional drafts.

The Contract Salary Index is increased based upon historical increases and current cost of living adjustments to achieve a projected number for each draft position for at least three previous years.

Calculating a potential claim payment is derived by subtracting a Threshold Value or Attachment Point from a Projected Value in the Contract Salary Index in each specific slot value within each respective sport for each individual offer for insurance coverage.

The Contract Salary Index is calculated from a combination of draft contract salaries including current and/or projected salaries for each draft slot position for each professional sport.

The system includes insurance policies comprising a plurality of policy attributes and assigns a rating system for each attribute.

In yet another embodiment, a range of projected payments based on an assigned claim value for each insurance policy from a first pick in a professional athlete draft to a last pick in the professional athlete draft is determined and identified. A potential claim payment for the athlete resulting in the athlete not being drafted as a result of illness and/or injury sustained during a defined insurance policy period can be determined.

Here, a projected claim amount is calculated for an undrafted free agent based on a signing bonus and a signed free agent agreement with an associated actual number of years.

The system provides a further assessment of contractual provisions to identify an insurance policy claim as a Permanent and Total Disability Claim or a Loss of Value Claim.

In addition, the system calculates a Lost Income Consequence based on choosing an objective or subjective loss of value contract versus that of another loss of value contract wherein both contracts have equal or greater benefits.

In another embodiment, the present disclosure provides a computer-implemented method comprising:

retrieving and determining by a computer-aided completion of multiple calculations which determine and compare dynamic maximum insurance policy liability payouts that change in value for one or more contractual compensation(s) for a professional individual wherein change of value of payouts is a dynamic threshold value minus a dynamic contract value wherein the threshold value is utilized by one or more syndicates within one or more insurance companies to ensure that a selected insurance policy covers a loss of payout that is less than the dynamic threshold value but greater than zero after the contract is completed and signed by the professional.

Here to, the professional individual is any one of a group consisting of; an amateur or professional athlete, a fireman, policeman, corporate employee, physician, engineer, construction worker, mail carrier, city or county civil employee, university administrator, athletics director, coach, and sports agent.

In another embodiment, the present disclosure includes one or more machine-readable hardware storage devices storing instructions that are executable by one or more processing devices to perform operations comprising: retrieving and determining by a computer a completion of multiple calculations that determine and compare dynamic maximum insurance policy liability payouts that change in value for one or more contractual compensation(s) for a professional individual wherein change in value of payouts is a dynamic threshold value minus a dynamic contract value wherein threshold value is utilized by one or more syndicates within one or more insurance companies to ensure that a selected insurance policy covers a loss of payout that is less than the threshold value but greater than zero after the contract is completed and signed by the professional.

Here again the professional individual is any one of a group consisting of; an amateur or professional athlete, a fireman, policeman, corporate employee, physician, engineer, construction worker, mail carrier, city or county civil employee, university administrator, athletics director, coach, and sports agent.

In yet another embodiment of the present disclosure, an electronic system is described comprising one or more processing devices and one or more machine-readable hardware storage devices storing instructions that are executable by one or more processing devices configured to perform operations further comprising: completion of multiple calculations that determine and compare dynamic maximum insurance policy liability payouts that change in value for one or more contractual compensation(s) for a professional individual wherein change of value of payouts is a dynamic threshold value minus a dynamic contract value wherein the threshold value is utilized by one or more syndicates within one or more insurance companies to ensure that a selected insurance policy covers a loss of payout that is less than the threshold value but greater than zero after the contract is completed and signed by the professional.

Here again the operations include provisions for professional individuals selected from any one of a group consisting of; an amateur or professional athlete, a fireman, policeman, corporate employee, physician, engineer, construction worker, mail carrier, city or county civil employee, university administrator, athletics director, coach, and sports agent.

In yet another embodiment, one or more devices for completion of multiple calculations are described comprising; determination and comparison of dynamic maximum insurance policy liability payouts that change in value for one or more contractual compensation(s) for a professional individual wherein change of value of payouts is a dynamic threshold value minus a dynamic contract value wherein the threshold value is utilized by one or more syndicates within one or more insurance companies to ensure that a selected insurance policy covers a loss of payout that is less than the threshold value but greater than zero after the contract is completed and signed by the professional and wherein the devices allow for continuously changing payouts based on continuously changing dynamics on a continuous basis.

Here, the devices provide multiple calculations that determine and compare dynamic maximum insurance policy liability payouts for professional individuals selected from any one of a group consisting of; an amateur or professional athlete, a fireman, policeman, corporate employee, physician, engineer, construction worker, mail carrier, city or county civil employee, university administrator, athletics director, coach, and sports agent.

### BRIEF DESCRIPTION OF THE DRAWINGS

FIG. 1 is a schematic representation of one embodiment of the present disclosure depicting a flow diagram indicating the process by which Lost Income Consequence Selection is determined for each position in the draft.

### DETAILED DESCRIPTION

In an embodiment of the present disclosure we provide a tool, system, and method for the analysis of potential claim(s) payments for Collegiate athlete potential draft candidates, current professional athletes within professional and collegiate sports not limited to football, basketball (men's and women's), ice hockey, soccer (men and women), baseball, and cricket, etc., as well as for public service men and women that risk bodily injury on the job. The disclosure includes providing a decision making tool that determines relative valuation of surplus lines accident/disability policy attributes and places via calculations, the synthesis of these relative valuations into a Salary Matrix for each contract being considered. In this case, surplus lines refers to a form of insurance under which the policies are written based on the jurisdiction in which the policies exist. This allows for flexibility and assigning risk that licensed insurers do not normally have. This analysis method can be used for the assessment and comparison of various claim payouts associated with an injury or illness while performing as a Collegiate or Professional Athlete, or professional service provider.

At present, many Collegiate Athletes are allowed and in fact encouraged to purchase disability insurance to protect themselves from losses against their future earnings due to an illness or injury incurred during the policy period. This type of insurance is different from any other insurance on the market due to several factors including:

1. The insurance policy has no systematic process for attaching values to policy offers written.
2. The insurance policy is purchased based upon speculation and offers from many different insurance companies/policy carriers with no supporting documentation as to how the carrier achieved a slot value or salary ranking for the individual insurance prospect.
3. The insurance policy pays out in a lump-sum manner once all of the benefit triggers have been satisfied, unlike traditional insurance which normally pays a monthly benefit for a predetermined number of years or months.
4. Underwriting for these insurance policies is performed under “surplus lines coverage” therefore bypassing state approval for coverage or coverage changes within the states in which the products are sold.
5. The insurance coverage is not held in a traditional manner, as in most cases with domestic carriers.

In this case and almost all current cases for these liability policies, Lloyd's of London provides the marketplace and syndicates hold the risk for each policy written. Insurance brokers typically approach collegiate athletes and their families (and/or NCAA member institutions) in order to sell “career ending and loss of value” insurance policies to protect the athlete against a catastrophic loss in the event of illness or injury. The student athlete, their family, and the Athletics Department cannot know how much the policy will actually pay out in the event of a claim due to several key factors. These factors include policy definitions, policy triggers, policy exclusions, professional salaries, draft slot values, and the professional athletic teams' evaluation and rankings of the prospect.

NCAA member institutions are also not able to distinguish one contract from another and there are no currently available identifiable methods in which to make an educated assessment of how much total monetary coverage to purchase regarding professional sports loss of income and loss of value due to the injury or illness incurred. The insurance policy is presented in a manner which indicates values for a catastrophic injury or illness as a result of an ended career, or a value for loss of income due to a drop from a relatively high projected draft ranking to a lower one thus producing a lower contract value within a particular sports draft. In order to trigger benefits, an “event” such as an accident or illness must be “identifiable”. This event differentiates Permanent and Total Disability also known as PTD and the Loss of Value rider or stand-alone policy also known as Loss of Value as being a unique product within the world of insurance. Benefit values, costs, and assumed claim payouts drive the process for decision makers who understand insurance policies and associated premiums. In the instance described above, however, the actual calculated claim payment or calculation for benefit is not available for the decision maker to make an assessment in how much coverage will actually be paid versus how much coverage will be purchased. The decision maker is generally shown a single proposal with no methodology or explanation of how benefits are calculated. Each individual collegiate athlete carries a unique set of characteristics which enables the underwriters to attach some risk (based upon evaluation of the athlete) assigned to each specific athlete within their respective sport. Risk evaluations and issue limits will be different for each underwriting syndicate and each athlete or other service professional that may be exposed to physical bodily injury and/or mental incapacity by carrying out the duties of their sport/profession. This situation creates the need for an analytical tool to measure the claim payments from each proposed coverholder and syndicate.

Currently, the NCAA encourages member institution athletics departments to collect and distinguish the benefits between the coverholders/insurers, insurance syndicates, and providers of coverage for Loss of Value. Not only does this burden the athletics compliance department with more work, but puts the institution at risk to act as an insurance advisor or broker. As they are not licensed to do this according to state statutes, the tool, system, and method of the present disclosure meet this unfulfilled need and reduces or eliminates the institution's liability by referring the athlete and family to a third party.

In the case of college athletes, proposals are prepared and provided in a non-solicited manner in many instances from the broker community. Brokers compete on the basis of previous historical written policy coverage versus the specificity of each unique athlete. Most if not all proposals are misleading regarding general benefit amounts listed. Solicitations for sales occur by directly contacting the Student Athlete, contacting the Student Athlete and their family, or directly contacting the athletics department. No system exists in calculating how much one contract will pay-out versus another for the given set of variables regarding a specific collegiate athlete in terms of loss of income in an upcoming professional draft. Qualitative impressions of contract quality are based solely on benefits proposed. A major issue with this approach is that a single human's brain cannot analyze the technical differences between the proposed amount of insurance and the actual claim pay-out that corresponds to each slot value within the professional draft, leading to inaccurate qualitative and subjective decisions. Currently, quantitative analytics are not considered or provided with each decision made for or by the athlete. Therefore, the decision for insurance policy coverage revolves around qualitative measures of contract values versus a quantitative measure of payment. Both factors—quality and quantity—must be considered to arrive at an appropriate decision for each individual.

In one embodiment, a method is provided that establishes a Loss of Value product that differs from all previous methods by virtue of one or more of the following: its qualitative and qualitative nature, it's underlying mathematical models and algorithms associated with each athlete respective to the corresponding professional sports draft, credible analysts' projections and synthesis of disparate issues and attributes for each individual athlete. The analysis and associated calculations can be used for the assessment and comparison of income loss within the various professional sports as well as for different service professions such as firefighters, police, EMTs, etc. The analysis provides decision makers with loss of value coverage with information not previously available to them.

One example of one embodiment of this technique accomplishes this through what is referred to herein as a method which can be carried out using one or more computing devices. The technique provides for each athlete to be considered in terms of a single unique identifiable characteristic provided as a “threshold value” as well as being identified as the dollar amount of income (minus $1) the athlete must sign for in order to begin collecting loss of value benefits. The threshold value in this instance is defined as the trigger point for a claim and therefore will be an assigned value as part of the loss of value contract.

Threshold values will vary greatly among coverholders/insurers and syndicates therefore the quantitative measurement is critical to the measurement of potential loss of income.

Each Draft Prospect is assigned a unique identifier to project their Potential Draft Slot Position (PDSP) in the future draft by each Coverholder or Insurance Company which is not made known, however the method uses a specific formula to calculate how each Coverholder or Insurance Company calculates their specific projection for insurability and liability purposes. Once this projection is calculated, the Draft Prospect is assigned a position within the Contract Salary Matrix (CSM) for each loss of value offer made.

TABLE I
PDSP Calculations to determine Draft Range based on the Individually
Assigned LVT:

| | | | | Projected |
|---|---|---|---|---|
| | | Relative | | Draft |
| | Assigned LVT: | Factor: | PDSP Value: | Position: |
| Coverholder | $5,800,000 | 0.6 | $9,666,667 | 27 |
| #1 | | | | |
| Coverholder | $2,400,000 | 0.6 | $4,000,000 | 64 |
| #2 | | | | |
| Coverholder | $7,600,000 | 0.6 | $12,666,667 | 14 |
| #3 | | | | |
| Insurance | $4,200,000 | 0.6 | $7,000,000 | 33 |
| Company #1 | | | | |

Table I demonstrates example differences in calculated PDSP's (projected draft slot positions) for the same Draft Prospect by various Loss of Value Providers.

The technique ad associated calculations include comparing Loss of Value Thresholds (LVTs) to one another on the basis of threshold value(s) compared to the actual or projected draft slot value (PDSV) for income in an up-coming draft by means of a Contract Salary Matrix that is calculated for each loss of value proposal considered attached to the specific professional sport category for each specific professional prospect and their given position together with the projected draft position. For each slot value within the professional draft evaluated, a Projected Payment Calculation (PPC) value is generated for each Loss of Value provider. Table illustrates variances in LVT by coverholders/insurers and insurance carriers associated with a single draft prospect. Table III provides parameters of the Contract Salary Matrix, Table IV provides the PDSP Values relative to the professional athlete draft prospect:

TABLE II
Assigned LVT's for each Insurance Offer NFL Prospect X

| Coverholder/Insurance | |
|---|---|
| Provider | Assigned LVT: |
| Coverholder #1 | $5,800,000 |
| Coverholder #2 | $2,400,000 |
| Coverholder #3 | $7,600,000 |
| Insurance Company #1 | $4,200,000 |

TABLE III
Contract Salary Matrix

| | Contract | Salary + Signing |
|---|---|---|
| Prior Year Draft Position: | Term: | Bonus: |
| 1 | 4 | $25,000,000 |
| 2 | 4 | $23,000,000 |
| 3 | 4 | $22,500,000 |
| . . . Positions 4-150 not illustrated | | |
| 151 | 4 | $2,585,914 |
| 152 | 4 | $2,584,895 |
| . . . Positions 153-200 not illustrated | | |
| 201 | 4 | $2,464,274 |
| 202 | 4 | $2,463,273 |

When the PPC is calculated via the required calculations with a formula that allows the PPC to be a negative number or “0”, the assigned PPC Value will be assigned a value of “0”. If the PPC is calculated as a positive number, the number will be reflected in the PPC column. The positive number reflected in the PPC Column will be a projected payment to the professional prospect if and only if all of the policy definitions and benefit triggers are satisfied within the associated Coverholder or Insurance Company as reflected within the Assigned LVT Column.

TABLE IV
PDSP Calculations to determine Draft Range based on the Individually
Assigned LVT

| | | | Projected |
|---|---|---|---|
| Assigned LVT / | Relative Factor: .60 = | PDSP Value | Draft Position |
| Coverholder #1 | 0.60 | $9,666,667 | 27 |
| $5,800,000 / | | | |
| Coverholder #2 | 0.60 | $4,000,000 | 64 |
| $2,400,000 / | | | |

TABLE IV
PDSP Calculations to determine Draft Range based on the Individually
Assigned LVT

| | | | |
|---|---|---|---|
| Coverholder #3 | 0.60 | $12,666,667 | 14 |
| $7,600,000 / | | | |
| Insurance Company | 0.60 | $7,000,000 | 33 |
| #1 $4,200,000 / | | | |

Below, Table V indicates a sample set of calculated values which are appropriately annotated for a typical National Football League Draft and is provided as a working Example.

TABLE V
Contract Salary Matrix

| | | | | | LOV Benefit | LOV Benefit | LOV Benefit |
|---|---|---|---|---|---|---|---|
| | | | | | Payable: CH1 | Payable: CH2 | Payable: CH3 |
| | | 2016 Total | | | $4,000,000 | $4,000,000 | $4,000,000 |
| | | Contract | 2017 | 2018 | Benefit*; | Benefit*; | Benefit*; |
| | Contract | Value | DOLLARS | DOLLARS | $6,552,306 | $4,250,000 | $8,800,000 |
| PICK | Years | Dollars: | PROJECTED** | PROJECTED** | Threshold | Threshold | Threshold |
| 1 | 4 | $27,937,673 | $28,761,834.35 | $29,610,308.47 | $0.00 | $0.00 | $0.00 |
| 2 | 4 | $26,676,338 | $27,463,289.97 | $28,273,457.03 | $0.00 | $0.00 | $0.00 |
| 3 | 4 | $25,873,686 | $26,636,959.74 | $27,422,750.05 | $0.00 | $0.00 | $0.00 |
| 4 | 4 | $24,956,341 | $25,692,553.06 | $26,450,483.37 | $0.00 | $0.00 | $0.00 |
| 5 | 4 | $23,351,000 | $24,039,854.50 | $24,749,030.21 | $0.00 | $0.00 | $0.00 |
| 6 | 4 | $20,484,331 | $21,088,618.76 | $21,710,733.02 | $0.00 | $0.00 | $0.00 |
| 7 | 4 | $18,190,995 | $18,727,629.35 | $19,280,094.42 | $0.00 | $0.00 | $0.00 |
| 8 | 4 | $15,897,658 | $16,366,638.91 | $16,849,454.76 | $0.00 | $0.00 | $0.00 |
| 9 | 4 | $15,782,861 | $16,248,455.40 | $16,727,784.83 | $0.00 | $0.00 | $0.00 |
| 10 | 4 | $15,152,320 | $15,599,313.44 | $16,059,493.19 | $0.00 | $0.00 | $0.00 |
| 11 | 4 | $14,177,661 | $14,595,902.00 | $15,026,481.11 | $0.00 | $0.00 | $0.00 |
| 12 | 4 | $12,801,648 | $13,179,296.62 | $13,568,085.87 | $0.00 | $0.00 | $0.00 |
| 13 | 4 | $12,457,650 | $12,825,150.68 | $13,203,492.62 | $0.00 | $0.00 | $0.00 |
| 14 | 4 | $11,884,317 | $12,234,904.35 | $12,595,834.03 | $0.00 | $0.00 | $0.00 |
| 15 | 4 | $11,654,997 | $11,998,819.41 | $12,352,784.58 | $0.00 | $0.00 | $0.00 |
| 16 | 4 | $10,966,980 | $11,290,505.91 | $11,623,575.83 | $0.00 | $0.00 | $0.00 |
| 17 | 4 | $10,737,645 | $11,054,405.53 | $11,380,510.49 | $0.00 | $0.00 | $0.00 |
| 18 | 4 | $10,450,983 | $10,759,287.00 | $11,076,685.96 | $0.00 | $0.00 | $0.00 |
| 19 | 4 | $10,278,977 | $10,582,206.82 | $10,894,381.92 | $0.00 | $0.00 | $0.00 |
| 20 | 4 | $10,221,648 | $10,523,186.62 | $10,833,620.62 | $0.00 | $0.00 | $0.00 |
| 21 | 4 | $10,164,313 | $10,464,160.23 | $10,772,852.96 | $0.00 | $0.00 | $0.00 |
| 22 | 4 | $10,049,642 | $10,346,106.44 | $10,651,316.58 | $0.00 | $0.00 | $0.00 |
| 23 | 4 | $9,934,979 | $10,228,060.88 | $10,529,788.68 | $0.00 | $0.00 | $0.00 |
| 24 | 4 | $9,705,644 | $9,991,960.50 | $10,286,723.33 | $0.00 | $0.00 | $0.00 |
| 25 | 4 | $9,590,981 | $9,873,914.94 | $10,165,195.43 | $0.00 | $0.00 | $0.00 |
| 26 | 4 | $9,476,296 | $9,755,846.73 | $10,043,644.21 | $0.00 | $0.00 | $0.00 |
| 27 | 4 | $9,361,646 | $9,637,814.56 | $9,922,130.09 | $0.00 | $0.00 | $0.00 |
| 28 | 4 | $9,304,311 | $9,578,788.17 | $9,861,362.43 | $0.00 | $0.00 | $0.00 |
| 29 | 4 | $8,600,601 | $8,854,318.73 | $9,115,521.13 | $0.00 | $0.00 | $0.00 |
| 30 | 4 | $8,396,514 | $8,644,211.16 | $8,899,215.39 | $0.00 | $0.00 | $0.00 |
| 31 | 4 | $8,265,105 | $8,508,925.60 | $8,759,938.90 | $0.00 | $0.00 | $0.00 |
| Round 2 | | TOTAL | | | | | |
| PICK | YRS | VALUE | | | | | |
| 32 | 4 | $6,609,641 | $6,804,625.41 | $7,005,361.86 | $0.00 | $0.00 | $1,794,638.14 |
| 33 | 4 | $6,552,306 | $6,745,599.03 | $6,944,594.20 | $0.00 | $0.00 | $1,855,405.80 |
| 34 | 4 | $6,494,970 | $6,686,571.62 | $6,883,825.48 | $0.00 | $0.00 | $1,916,174.52 |
| 35 | 4 | $6,380,307 | $6,568,526.06 | $6,762,297.58 | $0.00 | $0.00 | $2,037,702.42 |
| 36 | 4 | $6,334,441 | $6,521,307.01 | $6,713,685.57 | $0.00 | $0.00 | $2,086,314.43 |
| 37 | 4 | $6,231,229 | $6,415,050.26 | $6,604,294.24 | $0.00 | $0.00 | $2,195,705.76 |
| 38 | 4 | $6,128,039 | $6,308,816.15 | $6,494,926.23 | $57,379.77 | $0.00 | $2,305,073.77 |
| 39 | 4 | $6,036,301 | $6,214,371.88 | $6,397,695.85 | $154,610.15 | $0.00 | $2,402,304.15 |
| 40 | 4 | $5,944,571 | $6,119,935.84 | $6,300,473.95 | $251,832.05 | $0.00 | $2,499,526.05 |
| 41 | 4 | $5,841,370 | $6,013,690.42 | $6,191,094.28 | $361,211.72 | $0.00 | $2,608,905.72 |
| 42 | 4 | $5,749,639 | $5,919,253.35 | $6,093,871.32 | $458,434.68 | $0.00 | $2706,128.68 |
| 43 | 4 | $5,662,229 | $5,829,264.76 | $6,001,228.07 | $551,077.93 | $0.00 | $2,798,771.93 |
| 44 | 4 | $5,539,800 | $5,703,224.10 | $5,871,469.21 | $680,836.79 | $0.00 | $2,928,530.79 |
| 45 | 4 | $5,407,928 | $5,567,461.88 | $5,731,702.00 | $820,604.00 | $0.00 | $3,068,298.00 |
| 46 | 4 | $5,233,635 | $5,388,027.23 | $5,546,974.04 | $1,005,331.96 | $0.00 | $3,253,025.96 |
| 47 | 4 | $5,118,971 | $5,269,980.64 | $5,425,445.07 | $1,126,860.93 | $0.00 | $3,374,554.93 |
| 48 | 4 | $5,004,293 | $5,151,919.64 | $5,303,901.27 | $1,248,404.73 | $0.00 | $3,496,098.73 |
| 49 | 4 | $4,889,637 | $5,033,881.29 | $5,182,380.79 | $1,369,925.21 | $0.00 | $3,617,619.21 |
| 50 | 4 | $4,774,973 | $4,915,834.70 | $5,060,851.83 | $1,491,454.17 | $0.00 | $3,739,148.17 |
| 51 | 4 | $4,660,302 | $4,797,780.91 | $4,939,315.45 | $1,612,990.55 | $0.00 | $3,860,684.55 |
| 52 | 4 | $4,545,639 | $4,679,735.35 | $4,817,787.54 | $1,734,518.46 | $0.00 | $3,982,212.46 |
| 53 | 4 | $4,430,968 | $4,561,681.56 | $4,696,251.16 | $1,856,054.84 | $0.00 | $4,000,000.00 |
| 54 | 4 | $4,316,304 | $4,443,634.97 | $4,574,722.20 | $1,977,583.80 | $0.00 | $4,000,000.00 |
| 55 | 4 | $4,258,969 | $4,384,608.59 | $4,513,954.54 | $2,038,351.46 | $0.00 | $4,000,000.00 |
| 56 | 4 | $4,224,566 | $4,349,190.70 | $4,477,491.82 | $2,074,814.18 | $0.00 | $4,000,000.00 |
| 57 | 4 | $4,167,238 | $4,290,171.52 | $4,416,731.58 | $2,135,574.42 | $0.00 | $4,000,000.00 |
| 58 | 4 | $4,086,970 | $4,207,535.62 | $4,331,657.92 | $2,220,648.08 | $0.00 | $4,000,000.00 |
| 59 | 4 | $4,052,567 | $4,172,117.73 | $4,295,195.20 | $2,257,110.80 | $0.00 | $4,000,000.00 |
| 60 | 4 | $4,006,702 | $4,124,899.71 | $4,246,584.25 | $2,305,721.75 | $3,415.75 | $4,000,000.00 |
| 61 | 4 | $3,972,299 | $4,089,481.82 | $4,210,121.53 | $2,342,184.47 | $39,878.47 | $4,000,000.00 |
| 62 | 4 | $3,960,836 | $4,077,680.66 | $4,197,972.24 | $2,354,333.76 | $52,027.76 | $4,000,000.00 |
| 63 | 4 | $3,937,904 | $4,054,072.17 | $4,173,667.30 | $2,378,638.70 | $76,332.70 | $4,000,000.00 |
| Round 3 | | TOTAL | | | | | |
| PICK | YRS | VALUE | | | | | |
| 64 | 4 | $3,634,287 | $3,741,498.47 | $3,851,872.67 | $2,700,433.33 | $398,127.33 | $4,000,000.00 |
| 65 | 4 | $3,598,862 | $3,705,028.43 | $3,814,326.77 | $2,737,979.23 | $435,673.23 | $4,000,000.00 |
| 66 | 4 | $3,577,020 | $3,682,542.09 | $3,791,177.08 | $2,761,128.92 | $458,822.92 | $4,000,000.00 |
| 67 | — | — | — | | $0.00 | $0.00 | $0.00 |
| 68 | 4 | $3,541,704 | $3,646,184.27 | $3,753,746.70 | $2,798,559.30 | $496,253.30 | $4,000,000.00 |
| 69 | 4 | $3,480,587 | $3,583,264.32 | $3,688,970.61 | $2,863,335.39 | $561,029.39 | $4,000,000.00 |
| 70 | 4 | $3,455,055 | $3,556,979.12 | $3,661,910.01 | $2,890,395.99 | $588,089.99 | $4,000,000.00 |
| 71 | 4 | $3,457,136 | $3,559,121.51 | $3,664,115.60 | $2,888,190.40 | $585,884.40 | $4,000,000.00 |
| 72 | 4 | $3,413,520 | $3,514,218.84 | $3,617,888.30 | $2,934,417.70 | $632,111.70 | $4,000,000.00 |
| 73 | 4 | $3,381,260 | $3,481,007.17 | $3,583,696.88 | $2,968,609.12 | $666,303.12 | $4,000,000.00 |
| 74 | 4 | $3,363,128 | $3,462,340.28 | $3,564,479.31 | $2,987,826.69 | $685,520.69 | $4,000,000.00 |
| 75 | 4 | $3,298,632 | $3,395,941.64 | $3,496,121.92 | $3,056,184.08 | $753,878.08 | $4,000,000.00 |
| 76 | 4 | $3,278,816 | $3,375,541.07 | $3,475,119.53 | $3,077,186.47 | $774,880.47 | $4,000,000.00 |
| 77 | 4 | $3,237,684 | $3,333,195.68 | $3,431,524.95 | $3,120,781.05 | $818,475.05 | $4,000,000.00 |
| 78 | 4 | $3,213,428 | $3,308,224.13 | $3,405,816.74 | $3,146,489.26 | $844,183.26 | $4,000,000.00 |
| 79 | 4 | $3,200,864 | $3,295,289.49 | $3,392,500.53 | $3,159,805.47 | $857,499.47 | $4,000,000.00 |
| 80 | 4 | $3,189,296 | $3,283,380.23 | $3,380,239.95 | $3,172,066.05 | $869,760.05 | $4,000,000.00 |
| 81 | 4 | $3,213,428 | $3,308,224.13 | $3,405,816.74 | $3,146,489.26 | $844,183.26 | $4,000,000.00 |
| 82 | 4 | $3,142,732 | $3,235,442.59 | $3,330,888.15 | $3,221,417.85 | $919,111.85 | $4,000,000.00 |
| 83 | 4 | $3,123,920 | $3,216,075.64 | $3,310,949.87 | $3,241,356.13 | $939,050.13 | $4,000,000.00 |
| 84 | 4 | $3,123,424 | $3,215,565.01 | $3,310,424.18 | $3,241,881.82 | $939,575.82 | $4,000,000.00 |
| 85 | 3 | $3,114,299 | $3,206,170.82 | $3,300,752.86 | $3,251,553.14 | $949,247.14 | $4,000,000.00 |
| 86 | 4 | $3,100,388 | $3,191,849.45 | $3,286,009.00 | $3,266,297.00 | $963,991.00 | $4,000,000.00 |
| 87 | 4 | $3,110,629 | $3,202,392.56 | $3,296,863.14 | $3,255,442.86 | $953,136.86 | $4,000,000.00 |
| 88 | 4 | $3,134,328 | $3,226,790.68 | $3,321,981.00 | $3,230,325.00 | $928,019.00 | $4,000,000.00 |
| 89 | 4 | $3,114,256 | $3,206,126.55 | $3,300,707.29 | $3,251,598.71 | $949,292.71 | $4,000,000.00 |
| 90 | 4 | $3,112,464 | $3,204,281.69 | $3,298,808.00 | $3,253,498.00 | $951,192.00 | $4,000,000.00 |
| 91 | 4 | $3,410,832 | $3,511,451.54 | $3,615,039.36 | $2,937,266.64 | $634,960.64 | $4,000,000.00 |
| 92 | 4 | $3,082,696 | $3,173,635.53 | $3,267,257.78 | $3,285,048.22 | $982,742.22 | $4,000,000.00 |
| 93 | 4 | $3,389,082 | $3,489,059.92 | $3,591,987.19 | $2,960,318.81 | $658,012.81 | $4,000,000.00 |
| 94 | 4 | $3,056,880 | $3,147,057.96 | $3,239,896.17 | $3,312,409.83 | $1,010,103.83 | $4,000,000.00 |
| 95 (C) | 4 | $3,037,920 | $3,127,538.64 | $3,219,801.03 | $3,332,504.97 | $1,030,198.97 | $4,000,000.00 |
| 96 (C) | 4 | $3,030,420 | $3,119,817.39 | $3,211,852.00 | $3,340,454.00 | $1,038,148.00 | $4,000,000.00 |
| 97 (C) | 4 | $3,027,420 | $3,116,728.89 | $3,208,672.39 | $3,343,633.61 | $1,041,327.61 | $4,000,000.00 |
| 98 (C) | 4 | $3,069,552 | $3,160,103.78 | $3,253,326.85 | $3,298,979.15 | $996,673.15 | $4,000,000.00 |
| Round 4 | | TOTAL | | | | | |
| PICK | YRS | VALUE | | | | | |
| 99 | 4 | $2,973,956 | $3,061,687.70 | $3,152,007.49 | $3,400,298.51 | $1,097,992.51 | $4,000,000.00 |
| 100 | 4 | $2,959,890 | $3,047,206.76 | $3,137,099.35 | $3,415,206.65 | $1,112,900.65 | $4,000,000.00 |
| 101 | 4 | $2,957,880 | $3,045,137.46 | $3,134,969.02 | $3,417,336.98 | $1,115,030.98 | $4,000,000.00 |
| 102 | 4 | $2,954,084 | $3,041,229.48 | $3,130,945.75 | $3,421,360.25 | $1,119,054.25 | $4,000,000.00 |
| 103 | 4 | $2,948,410 | $3,035,388.10 | $3,124,932.04 | $3,427,373.96 | $1,125,067.96 | $4,000,000.00 |
| 104 | 4 | $2,945,130 | $3,032,011.34 | $3,121,455.67 | $3,430,850.33 | $1,128,544.33 | $4,000,000.00 |
| 105 | 4 | $2,970,410 | $3,058,037.10 | $3,148,249.19 | $3,404,056.81 | $1,101,750.81 | $4,000,000.00 |
| 106 | 4 | $2,967,303 | $3,054,838.44 | $3,144,956.17 | $3,407,349.83 | $1,105,043.83 | $4,000,000.00 |
| 107 | 4 | $2,936,360 | $3,022,982.62 | $3,112,160.61 | $3,440,145.39 | $1,137,839.39 | $4,000,000.00 |
| 108 | 4 | $2,932,161 | $3,018,659.75 | $3,107,710.21 | $3,444,595.79 | $1,142,289.79 | $4,000,000.00 |
| 109 | 4 | $2,922,207 | $3,008,412.11 | $3,097,160.26 | $3,455,145.74 | $1,152,839.74 | $4,000,000.00 |
| 110 | 4 | $2,920,860 | $3,007,025.37 | $3,095,732.62 | $3,456,573.38 | $1,154,267.38 | $4,000,000.00 |
| 111 | 4 | $2,918,564 | $3,004,661.64 | $3,093,299.16 | $3,459,006.84 | $1,156,700.84 | $4,000,000.00 |
| 112 | 4 | $2,917,992 | $3,004,072.76 | $3,092,692.91 | $3,459,613.09 | $1,157,307.09 | $4,000,000.00 |
| 113 | 4 | $2,915,120 | $3,001,116.04 | $3,089,648.96 | $3,462,657.04 | $1,160,351.04 | $4,000,000.00 |
| 114 | 4 | $2,907,850 | $2,993,631.58 | $3,081,943.71 | $3,470,362.29 | $1,168,056.29 | $4,000,000.00 |
| 115 | 4 | $2,905,528 | $2,991,241.08 | $3,079,482.69 | $3,472,823.31 | $1,170,517.31 | $4,000,000.00 |
| 116 | 4 | $2,900,222 | $2,985,778.55 | $3,073,859.02 | $3,478,446.98 | $1,176,140.98 | $4,000,000.00 |
| 117 | 4 | $2,894,666 | $2,980,058.65 | $3,067,970.38 | $3,484,335.62 | $1,182,029.62 | $4,000,000.00 |
| 118 | 4 | $2,891,131 | $2,976,419.36 | $3,064,223.74 | $3,488,082.26 | $1,185,776.26 | $4,000,000.00 |
| 119 | 4 | $2,887,569 | $2,972,752.29 | $3,060,448.48 | $3,491,857.52 | $1,189,551.52 | $4,000,000.00 |
| 120 | 4 | $2,882,345 | $2,967,374.18 | $3,054,911.72 | $3,497,394.28 | $1,195,088.28 | $4,000,000.00 |
| 121 | 4 | $2,875,845 | $2,960,682.43 | $3,048,022.56 | $3,504,283.44 | $1,201,977.44 | $4,000,000.00 |
| 122 | 4 | $2,875,845 | $2,960,682.43 | $3,048,022.56 | $3,504,283.44 | $1,201,977.44 | $4,000,000.00 |
| 123 | 4 | $2,870,488 | $2,955,167.40 | $3,042,344.83 | $3,509,961.17 | $1,207,655.17 | $4,000,000.00 |
| 124 | 4 | $2,866,218 | $2,950,771.43 | $3,037,819.19 | $3,514,486.81 | $1,212,180.81 | $4,000,000.00 |
| 125 | 4 | $2,859,906 | $2,944,273.23 | $3,031,129.29 | $3,521,176.71 | $1,218,870.71 | $4,000,000.00 |
| 126 | 4 | $2,857,172 | $2,941,458.57 | $3,028,231.60 | $3,524,074.40 | $1,221,768.40 | $4,000,000.00 |
| 127 | 4 | $2,850,891 | $2,934,992.28 | $3,021,574.56 | $3,530,731.44 | $1,228,425.44 | $4,000,000.00 |
| 128 | 4 | $2,846,483 | $2,930,454.25 | $3,016,902.65 | $3,535,403.35 | $1,233,097.35 | $4,000,000.00 |
| 129 | 4 | $2,839,356 | $2,923,117.00 | $3,009,348.95 | $3,542,957.05 | $1,240,651.05 | $4,000,000.00 |
| 130 | 4 | $2,831,897 | $2,915,437.96 | $3,001,443.38 | $3,550,862.62 | $1,248,556.62 | $4,000,000.00 |
| 131 (C) | 4 | $2,723,393 | $2,803,733.09 | $2,886,443.22 | $3,665,862.78 | $1,363,556.78 | $4,000,000.00 |
| 132 (C) | 4 | $2,723,393 | $2,803,733.09 | $2,886,443.22 | $3,665,862.78 | $1,363,556.78 | $4,000,000.00 |
| 133 (C) | 4 | $2,723,393 | $2,803,733.09 | $2,886,443.22 | $3,665,862.78 | $1,363,556.78 | $4,000,000.00 |
| 134 (C) | 4 | $2,723,393 | $2,803,733.09 | $2,886,443.22 | $3,665,862.78 | $1,363,556.78 | $4,000,000.00 |
| 135 (C) | 4 | $2,723,393 | $2,803,733.09 | $2,886,443.22 | $3,665,862.78 | $1,363,556.78 | $4,000,000.00 |
| 136 (C) | 4 | $2,723,393 | $2,803,733.09 | $2,886,443.22 | $3,665,862.78 | $1,363,556.78 | $4,000,000.00 |
| 137 (C) | 4 | $2,723,393 | $2,803,733.09 | $2,886,443.22 | $3,665,862.78 | $1,363,556.78 | $4,000,000.00 |
| 138 (C) | 4 | $2,723,393 | $2,803,733.09 | $2,886,443.22 | $3,665,862.78 | $1,363,556.78 | $4,000,000.00 |
| 139 (C) | 4 | $2,723,393 | $2,803,733.09 | $2,886,443.22 | $3,665,862.78 | $1,363,556.78 | $4,000,000.00 |
| Round 5 | | TOTAL | | | | | |
| PICK | YRS | VALUE | | | | | |
| 140 | 4 | $2,614,884 | $2,692,023.08 | $2,771,437.76 | $3,780,868.24 | $1,478,562.24 | $4,000,000.00 |
| 141 | 4 | $2,612,461 | $2,689,528.60 | $2,768,869.69 | $3,783,436.31 | $1,481,130.31 | $4,000,000.00 |
| 142 | 4 | $2,610,405 | $2,687,411.95 | $2,766,690.60 | $3,785,615.40 | $1,483,309.40 | $4,000,000.00 |
| 143 | 4 | $2,609,195 | $2,686,166.25 | $2,765,408.16 | $3,786,897.84 | $1,484,591.84 | $4,000,000.00 |
| 144 | 4 | $2,603,900 | $2,680,715.05 | $2,759,796.14 | $3,792,509.86 | $1,490,203.86 | $4,000,000.00 |
| 145 | 4 | $2,597,614 | $2,674,243.61 | $2,753,133.80 | $3,799,172.20 | $1,496,866.20 | $4,000,000.00 |
| 146 | 4 | $2,595,736 | $2,672,310.21 | $2,751,143.36 | $3,801,162.64 | $1,498,856.64 | $4,000,000.00 |
| 147 | 4 | $2,593,823 | $2,670,340.78 | $2,749,115.83 | $3,803,190.17 | $1,500,884.17 | $4,000,000.00 |
| 148 | 4 | $2,593,185 | $2,669,683.96 | $2,748,439.63 | $3,803,866.37 | $1,501,560.37 | $4,000,000.00 |
| 149 | 4 | $2,592,548 | $2,669,028.17 | $2,747,764.50 | $3,804,541.50 | $1,502,235.50 | $4,000,000.00 |
| 150 | 4 | $2,588,022 | $2,664,368.65 | $2,742,967.52 | $3,809,338.48 | $1,507,032.48 | $4,000,000.00 |
| 151 | 4 | $2,585,915 | $2,662,199.49 | $2,740,734.38 | $3,811,571.62 | $1,509,265.62 | $4,000,000.00 |
| 152 | 4 | $2,584,895 | $2,661,149.40 | $2,739,653.31 | $3,812,652.69 | $1,510,346.69 | $4,000,000.00 |
| 153 | 4 | $2,584,578 | $2,660,823.05 | $2,739,317.33 | $3,812,988.67 | $1,510,682.67 | $4,000,000.00 |
| 154 | 4 | $2,584,002 | $2,660,230.06 | $2,738,706.85 | $3,813,599.15 | $1,511,293.15 | $4,000,000.00 |
| 155 | 4 | $2,582,410 | $2,658,591.10 | $2,737,019.53 | $3,815,286.47 | $1,512,980.47 | $4,000,000.00 |
| 156 | 4 | $2,580,915 | $2,657,051.99 | $2,735,435.03 | $3,816,870.97 | $1,514,564.97 | $4,000,000.00 |
| 157 | 4 | $2,578,186 | $2,654,242.49 | $2,732,542.64 | $3,819,763.36 | $1,517,457.36 | $4,000,000.00 |
| 158 | 4 | $2,575,966 | $2,651,957.00 | $2,730,189.73 | $3,822,116.27 | $1,519,810.27 | $4,000,000.00 |
| 159 | 4 | $2,574,936 | $2,650,896.61 | $2,729,098.06 | $3,823,207.94 | $1,520,901.94 | $4,000,000.00 |
| 160 | 4 | $2,572,681 | $2,648,575.09 | $2,726,708.05 | $3,825,597.95 | $1,523,291.95 | $4,000,000.00 |
| 161 | 4 | $2,571,696 | $2,647,561.03 | $2,725,664.08 | $3,826,641.92 | $1,524,335.92 | $4,000,000.00 |
| 162 | 4 | $2,595,216 | $2,671,774.87 | $2,750,592.23 | $3,801,713.77 | $1,499,407.77 | $4,000,000.00 |
| 163 | 4 | $2,567,176 | $2,642,907.69 | $2,720,873.47 | $3,831,432.53 | $1,529,126.53 | $4,000,000.00 |
| 164 | 4 | $2,565,125 | $2,640,796.19 | $2,718,699.68 | $3,833,606.32 | $1,531,300.32 | $4,000,000.00 |
| 165 | 4 | $2,586,220 | $2,662,513.49 | $2,741,057.64 | $3,811,248.36 | $1,508,942.36 | $4,000,000.00 |
| 166 | 4 | $2,555,380 | $2,630,763.71 | $2,708,371.24 | $3,843,934.76 | $1,541,628.76 | $4,000,000.00 |
| 167 | 4 | $2,550,201 | $2,625,431.93 | $2,702,882.17 | $3,849,423.83 | $1,547,117.83 | $4,000,000.00 |
| 168 | 4 | $2,547,650 | $2,622,805.68 | $2,700,178.44 | $3,852,127.56 | $1,549,821.56 | $4,000,000.00 |
| 169 | 4 | $2,544,462 | $2,619,523.63 | $2,696,799.58 | $3,855,506.42 | $1,553,200.42 | $4,000,000.00 |
| 170 (C) | 4 | $2,524,385 | $2,598,854.36 | $2,675,520.56 | $3,876,785.44 | $1,574,479.44 | $4,000,000.00 |
| 171 (C) | 4 | $2,524,385 | $2,598,854.36 | $2,675,520.56 | $3,876,785.44 | $1,574,479.44 | $4,000,000.00 |
| 172 (C) | 4 | $2,524,385 | $2,598,854.36 | $2,675,520.56 | $3,876,785.44 | $1,574,479.44 | $4,000,000.00 |
| 173 (C) | 4 | $2,524,385 | $2,598,854.36 | $2,675,520.56 | $3,876,785.44 | $1,574,479.44 | $4,000,000.00 |
| 174 (C) | 4 | $2,524,385 | $2,598,854.36 | $2,675,520.56 | $3,876,785.44 | $1,574,479.44 | $4,000,000.00 |
| 175 (C) | 4 | $2,524,385 | $2,598,854.36 | $2,675,520.56 | $3,876,785.44 | $1,574,479.44 | $4,000,000.00 |
| Round 6 | | TOTAL | | | | | |
| PICK | YRS | VALUE | | | | | |
| 176 | 4 | $2,504,309 | $2,578,186.12 | $2,654,242.61 | $3,898,063.39 | $1,595,757.39 | $4,000,000.00 |
| 177 | 4 | $2,499,585 | $2,573,322.76 | $2,649,235.78 | $3,903,070.22 | $1,600,764.22 | $4,000,000.00 |
| 178 | 4 | $2,524,513 | $2,598,986.13 | $2,675,656.22 | $3,876,649.78 | $1,574,343.78 | $4,000,000.00 |
| 179 | 4 | $2,493,825 | $2,567,392.84 | $2,643,130.93 | $3,909,175.07 | $1,606,869.07 | $4,000,000.00 |
| 180 | 4 | $2,490,421 | $2,563,888.42 | $2,639,523.13 | $3,912,782.87 | $1,610,476.87 | $4,000,000.00 |
| 181 | 4 | $2,487,687 | $2,561,073.77 | $2,636,625.44 | $3,915,680.56 | $1,613,374.56 | $4,000,000.00 |
| 182 | 4 | $2,485,947 | $2,559,282.44 | $2,634,781.27 | $3,917,524.73 | $1,615,218.73 | $4,000,000.00 |
| 183 | 4 | $2,484,707 | $2,558,005.86 | $2,633,467.03 | $3,918,838.97 | $1,616,532.97 | $4,000,000.00 |
| 184 | 4 | $2,482,855 | $2,556,099.22 | $2,631,504.15 | $3,920,801.85 | $1,618,495.85 | $4,000,000.00 |
| 185 | 4 | $2,480,942 | $2,554,129.79 | $2,629,476.62 | $3,922,829.38 | $1,620,523.38 | $4,000,000.00 |
| 186 | 4 | $2,480,381 | $2,553,552.24 | $2,628,882.03 | $3,923,423.97 | $1,621,117.97 | $4,000,000.00 |
| 187 | 4 | $2,477,335 | $2,550,416.38 | $2,625,653.67 | $3,926,652.33 | $1,624,346.33 | $4,000,000.00 |
| 188 | 4 | $2,475,457 | $2,548,482.98 | $2,623,663.23 | $3,928,642.77 | $1,626,336.77 | $4,000,000.00 |
| 189 | 4 | $2,474,947 | $2,547,957.94 | $2,623,122.70 | $3,929,183.30 | $1,626,877.30 | $4,000,000.00 |
| 190 | 4 | $2,474,320 | $2,547,312.44 | $2,622,458.16 | $3,929,847.84 | $1,627,541.84 | $4,000,000.00 |
| 191 | 4 | $2,473,738 | $2,546,713.27 | $2,621,841.31 | $3,930,464.69 | $1,628,158.69 | $4,000,000.00 |
| 192 | 4 | $2,472,932 | $2,545,883.49 | $2,620,987.06 | $3,931,318.94 | $1,629,012.94 | $4,000,000.00 |
| 193 | 4 | $2,472,743 | $2,545,688.92 | $2,620,786.74 | $3,931,519.26 | $1,629,213.26 | $4,000,000.00 |
| 194 | 4 | $2,472,478 | $2,545,416.10 | $2,620,505.88 | $3,931,800.12 | $1,629,494.12 | $4,000,000.00 |
| 195 | 4 | $2,472,381 | $2,545,316.24 | $2,620,403.07 | $3,931,902.93 | $1,629,596.93 | $4,000,000.00 |
| 196 | 4 | $2,471,570 | $2,544,481.32 | $2,619,543.51 | $3,932,762.49 | $1,630,456.49 | $4,000,000.00 |
| 197 | 4 | $2,470,355 | $2,543,230.47 | $2,618,255.77 | $3,934,050.23 | $1,631,744.23 | $4,000,000.00 |
| 198 | 4 | $2,469,682 | $2,542,537.62 | $2,617,542.48 | $3,934,763.52 | $1,632,457.52 | $4,000,000.00 |
| 199 | 4 | $2,467,932 | $2,540,735.99 | $2,615,687.71 | $3,936,618.29 | $1,634,312.29 | $4,000,000.00 |
| 200 | 4 | $2,466,141 | $2,538,892.16 | $2,613,789.48 | $3,938,516.52 | $1,636,210.52 | $4,000,000.00 |
| 201 | 4 | $2,464,274 | $2,536,970.08 | $2,611,810.70 | $3,940,495.30 | $1,638,189.30 | $4,000,000.00 |
| 202 | 4 | $2,463,723 | $2,536,402.83 | $2,611,226.71 | $3,941,079.29 | $1,638,773.29 | $4,000,000.00 |
| 203 | 4 | $2,490,713 | $2,564,189.03 | $2,639,832.61 | $3,912,473.39 | $1,610,167.39 | $4,000,000.00 |
| 204 | 4 | $2,459,963 | $2,532,531.91 | $2,607,241.60 | $3,945,064.40 | $1,642,758.40 | $4,000,000.00 |
| 205 | 4 | $2,457,998 | $2,530,508.94 | $2,605,158.95 | $3,947,147.05 | $1,644,841.05 | $4,000,000.00 |
| 206 | 4 | $2,456,070 | $2,528,524.07 | $2,603,115.52 | $3,949,190.48 | $1,646,884.48 | $4,000,000.00 |
| 207 | 4 | $2,452,539 | $2,524,888.90 | $2,599,373.12 | $3,952,932.88 | $1,650,626.88 | $4,000,000.00 |
| 208 (C) | 4 | $2,440,356 | $2,512,346.50 | $2,586,460.72 | $3,965,845.28 | $1,663,539.28 | $4,000,000.00 |
| 209 (C) | 4 | $2,440,356 | $2,512,346.50 | $2,586,460.72 | $3,965,845.28 | $1,663,539.28 | $4,000,000.00 |
| 210 (C) | 4 | $2,440,356 | $2,512,346.50 | $2,586,460.72 | $3,965,845.28 | $1,663,539.28 | $4,000,000.00 |
| 211 (C) | 4 | $2,440,356 | $2,512,346.50 | $2,586,460.72 | $3,965,845.28 | $1,663,539.28 | $4,000,000.00 |
| 212 (C) | 4 | $2,440,356 | $2,512,346.50 | $2,586,460.72 | $3,965,845.28 | $1,663,539.28 | $4,000,000.00 |
| 213 (C) | 4 | $2,440,356 | $2,512,346.50 | $2,586,460.72 | $3,965,845.28 | $1,663,539.28 | $4,000,000.00 |
| 214 (C) | 4 | $2,440,356 | $2,512,346.50 | $2,586,460.72 | $3,965,845.28 | $1,663,539.28 | $4,000,000.00 |
| 215 (C) | 4 | $2,440,356 | $2,512,346.50 | $2,586,460.72 | $3,965,845.28 | $1,663,539.28 | $4,000,000.00 |
| 216 (C) | 4 | $2,440,356 | $2,512,346.50 | $2,586,460.72 | $3,965,845.28 | $1,663,539.28 | $4,000,000.00 |
| 217 (C) | 4 | $2,440,356 | $2,512,346.50 | $2,586,460.72 | $3,965,845.28 | $1,663,539.28 | $4,000,000.00 |
| 218 (C) | 4 | $2,440,356 | $2,512,346.50 | $2,586,460.72 | $3,965,845.28 | $1,663,539.28 | $4,000,000.00 |
| 219 (C) | 4 | $2,440,356 | $2,512,346.50 | $2,586,460.72 | $3,965,845.28 | $1,663,539.28 | $4,000,000.00 |
| 220 (C) | 4 | $2,440,356 | $2,512,346.50 | $2,586,460.72 | $3,965,845.28 | $1,663,539.28 | $4,000,000.00 |
| 221 (C) | 4 | $2,440,356 | $2,512,346.50 | $2,586,460.72 | $3,965,845.28 | $1,663,539.28 | $4,000,000.00 |
| Round 7 | | TOTAL | | | | | |
| PICK | YRS | VALUE | | | | | |
| 222 | 4 | $2,428,167 | $2,499,797.93 | $2,573,541.97 | $3,978,764.03 | $1,676,458.03 | $4,000,000.00 |
| 223 | 4 | $2,427,881 | $2,499,503.49 | $2,573,238.84 | $3,979,067.16 | $1,676,761.16 | $4,000,000.00 |
| 224 | 4 | $2,426,096 | $2,497,665.83 | $2,571,346.97 | $3,980,959.03 | $1,678,653.03 | $4,000,000.00 |
| 225 | 4 | $2,425,412 | $2,496,961.65 | $2,570,622.02 | $3,981,683.98 | $1,679,377.98 | $4,000,000.00 |
| 226 | 4 | $2,423,096 | $2,494,577.33 | $2,568,167.36 | $3,984,138.64 | $1,681,832.64 | $4,000,000.00 |
| 227 | 4 | $2,421,290 | $2,492,718.06 | $2,566,253.24 | $3,986,052.76 | $1,683,746.76 | $4,000,000.00 |
| 228 | 4 | $2,420,009 | $2,491,399.27 | $2,564,895.54 | $3,987,410.46 | $1,685,104.46 | $4,000,000.00 |
| 229 | 4 | $2,419,652 | $2,491,031.73 | $2,564,517.17 | $3,987,788.83 | $1,685,482.83 | $4,000,000.00 |
| 230 | 4 | $2,419,397 | $2,490,769.21 | $2,564,246.90 | $3,988,059.10 | $1,685,753.10 | $4,000,000.00 |
| 231 | 4 | $2,418,851 | $2,490,207.10 | $2,563,668.21 | $3,988,637.79 | $1,686,331.79 | $4,000,000.00 |
| 232 | 4 | $2,417,296 | $2,488,606.23 | $2,562,020.12 | $3,990,285.88 | $1,687,979.88 | $4,000,000.00 |
| 233 | 4 | $2,416,856 | $2,488,153.25 | $2,561,553.77 | $3,990,752.23 | $1,688,446.23 | $4,000,000.00 |
| 234 | 4 | $2,416,846 | $2,488,142.96 | $2,561,543.17 | $3,990,762.83 | $1,688,456.83 | $4,000,000.00 |
| 235 | 4 | $2,415,795 | $2,487,060.95 | $2,560,429.25 | $3,991,876.75 | $1,689,570.75 | $4,000,000.00 |
| 236 | 4 | $2,415,764 | $2,487,029.04 | $2,560,396.39 | $3,991,909.61 | $1,689,603.61 | $4,000,000.00 |
| 237 | 4 | $2,415,479 | $2,486,735.63 | $2,560,094.33 | $3,992,211.67 | $1,689,905.67 | $4,000,000.00 |
| 238 | 4 | $2,413,785 | $2,484,991.66 | $2,558,298.91 | $3,994,007.09 | $1,691,701.09 | $4,000,000.00 |
| 239 | 4 | $2,412,509 | $2,483,678.02 | $2,556,946.52 | $3,995,359.48 | $1,693,053.48 | $4,000,000.00 |
| 240 | 4 | $2,411,366 | $2,482,501.30 | $2,555,735.09 | $3,996,570.91 | $1,694,264.91 | $4,000,000.00 |
| 241 | 4 | $2,408,382 | $2,479,429.27 | $2,552,572.43 | $3,999,733.57 | $1,697,427.57 | $4,000,000.00 |
| 242 | 4 | $2,405,550 | $2,476,513.73 | $2,549,570.88 | $4,000,000.00 | $1,700,429.12 | $4,000,000.00 |
| 243 | 4 | $2,404,897 | $2,475,841.46 | $2,548,878.78 | $4,000,000.00 | $1,701,121.22 | $4,000,000.00 |
| 244 | 4 | $2,404,224 | $2,475,148.61 | $2,548,165.49 | $4,000,000.00 | $1,701,834.51 | $4,000,000.00 |
| 245 | 4 | $2,403,550 | $2,474,454.73 | $2,547,451.14 | $4,000,000.00 | $1,702,548.86 | $4,000,000.00 |
| 246 | 4 | $2,403,050 | $2,473,939.98 | $2,546,921.20 | $4,000,000.00 | $1,703,078.80 | $4,000,000.00 |
| 247 | 4 | $2,402,499 | $2,473,372.72 | $2,546,337.22 | $4,000,000.00 | $1,703,662.78 | $4,000,000.00 |
| 248 | 4 | $2,401,989 | $2,472,847.68 | $2,545,796.68 | $4,000,000.00 | $1,704,203.32 | $4,000,000.00 |
| 249 | 4 | $2,401,479 | $2,472,322.63 | $2,545,256.15 | $4,000,000.00 | $1,704,743.85 | $4,000,000.00 |
| 250 | 4 | $2,400,703 | $2,471,523.74 | $2,544,433.69 | $4,000,000.00 | $1,705,566.31 | $4,000,000.00 |
| 251 | 4 | $2,400,137 | $2,470,941.04 | $2,543,833.80 | $4,000,000.00 | $1,706,166.20 | $4,000,000.00 |
| 252 | 4 | $2,399,326 | $2,470,106.12 | $2,542,974.25 | $4,000,000.00 | $1,707,025.75 | $4,000,000.00 |
| 253 | 4 | $2,398,540 | $2,469,296.93 | $2,542,141.19 | $4,000,000.00 | $1,707,858.81 | $4,000,000.00 |

By combining the relevant data generated from Tables I, II, III, and IV we are able to construct Table V which shows (with quantitative precision) each potential draft position claim value relative to the unique LVT assigned by each insurance company. Each PPC is calculated using the process of determining the projected draft position for an athlete and assigning each LVT for each insurance coverage proposal for coverage where the LVT is a number greater than Zero as shown in Table V. As this example demonstrates for illustrative purposes only, Coverholder #1 has determined that their projected payment (PPC) will begin at draft position/slot #38 in the upcoming NFL Draft with a projected claim payment of $57,379.77 should the athlete be drafted in that position due to injury or illness.

Coverholder #2 has determined that their projected payment claim (PPC) will begin at draft position/slot #60 in the upcoming NFL Draft with a projected claim payment of $3,415.75 should the athlete be drafted in that position due to injury or illness.

Coverholder #3 has determined that their projected payment (PPC) will begin at draft position/slot #32 in the upcoming NFL Draft with a projected claim payment of $1,794,638.14 should the athlete be drafted in that position due to injury or illness.

It should be noted here that all insurance offers and associated policies for coverage were given the same nominal “advertised value” of $4,000,000. However, as demonstrated the payment will vary greatly among the coverholder contracts based upon the assigned LVT. Further it is shown that a drop to the 249th position in the NFL draft will generate the following results:

### Coverholder #1: Claim Payment=$4,000,000

### Coverholder #2: Claim Payment=$1,704,744

### Coverholder #3: Claim Payment=$4,000,000

As proven by the calculations that provide the values in Table V, an “advertised coverage amount” of a $4,000,000 disability policy to protect the athlete from falling in the draft due to injury or illness may not (and frequently does not) pay out the full benefit as advertised in the offered coverage amount. The present disclosure provides the only known analytical technique and tool to determine such payments when comparing one or more insurance contracts.

As with other salary and insurance contracts, value is a function of numerous contractual attributes (variables). The following list identifies many, but not all, of the variables relevant to the determination of value for a Loss of Value claim:
PTD Benefit Amount,
LoV Benefit Amount,
Threshold,
Single Identifiable Event of Accident,
Bodily Injury,
Illness,
Sickness,
Manifests
Minimum Contract Offer from Professional Sport's Team/Organization
Recovery Period
Benefit Recovery
Ascertained Net Loss
Compensation
Indemnity
Salary
Signing Bonus
Roster Bonus
Reporting Bonus
Indemnity Period
Cancellation Fee
Contract
Professional Football Team
Subrogation
Limit of Indemnity
Health Care Professional
Medical History Questionnaire
Assured
Permanent and Total Disablement
Total Disablement
Occupation/Sport
Proposal Form
Underwriters
Subrogation
Totally Disabled
Participate
Period of Insurance
and Exclusions.

Loss of Value Payment Calculations (LVPCs) are determined by the Coverholder/Insurance Company's assigned “threshold value” and calculating a Specific Threshold for each insurance policy's representative of coverage with previous and current NFL Draft Results and relative Slot Values associated with each Draft Position in the draft. Future Value Contract Benefits (FVCBs) contained in the Salary Index are calculated by algorithms or formulas which predict the future Slot Value for each Draft Position. This is accomplished by taking previous increases over the past 3 years and assigning an average increase value to project the future draft position values for the upcoming professional draft. This is a critical aspect of the calculations as it is used to project potential payments or more importantly potential differences between the amount of insurance offered versus the amount of insurance which will actually pay out in the event of a claim. FVCBs are determined by using historical data of Slot Value increases to calculate a Minimum Estimated Slot Value (MESV) for the upcoming draft and associated valuation minimums. Any changes to the increase or decrease in the MESV by the actual increase in slot value will be factored into the formula once (in this instance) the NFL has released those specifics.

For this specific example, the vast amount of historical slot values as well as specific player attributes such as position, historical collegiate performance, NFL Combine performance, height, weight, speed, strength, and other factors relating to NFL/Professional team positions relative to the draft, specific position and team needs and salary cap data permits the determination for Threshold values, FVCBs and MESV's by using, in this specific instance multivariate data analysis relative to the players available for a draft or signing to a contract.

In this instance, an NFL Draft Prospect having eligibility for the upcoming NFL Draft will be assessed to determine where each coverholder predicts the prospect will be drafted. Then each Loss of Value offer will be compared to the calculated FVCB's, and one or more MESVs, to determine a projected payment for each position in the upcoming NFL Draft.

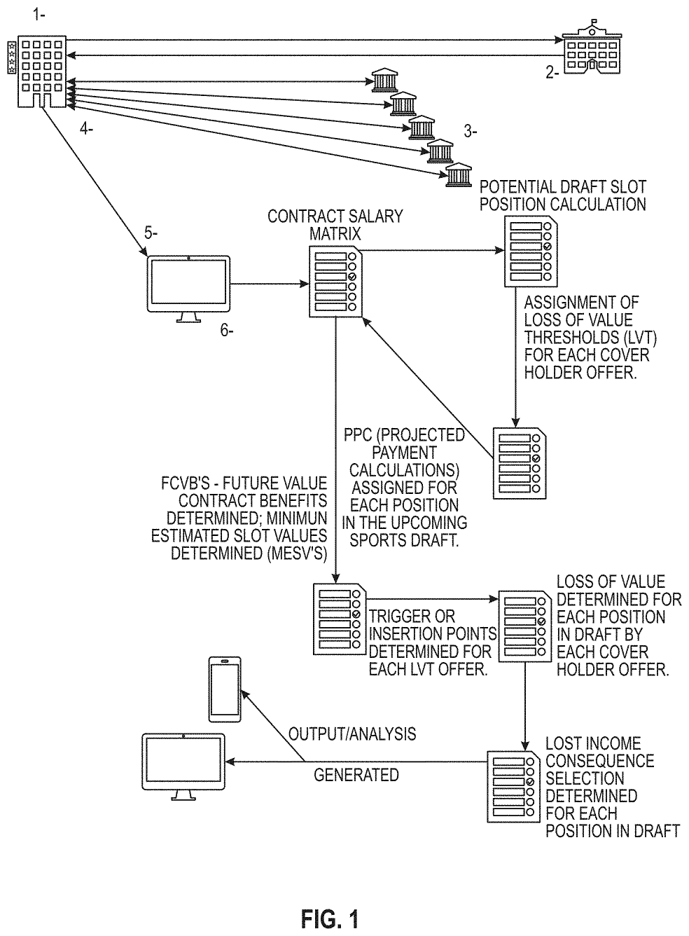

FIG. 1 is a schematic diagram and associated flow chart that indicates the general process which is a consulting arrangement that can employ the tool or tools which may exist on one or more devices to arrive at decision making alternatives. The devices can either exist in or on one or more computers or computer platforms as descried in the summary above.

For FIG. 1, the flow is as follows;

### Step 1:

IPC, Inc (a third party entity), signs an exclusive agreement to consult with Institution (Conference, University/College, Athletics Department, Sports Agent, Sports Agency Firm, Bank, Financial Advisor, Trust Department, Insurance Agent, Insurance Agency), or Individual Athlete regarding Consultative Services for advising the Institution and Institution Members for Permanent and Total Disability Coverage as well as Loss of Value Rider Insurance Coverage.

### Step 2:

The Institution requests roster analysis from IPC, Inc. for all athletes eligible to be insured for Permanent and Total Disability and Loss of Value Coverage with Lloyds of London or other similar surplus lines re-insurance providers. This includes, but is not limited to Football, Men's Basketball, Women's Basketball, Ice Hockey, Baseball, Men's Soccer, Women's Soccer, Men's Golf, Women's Golf, and Olympic Sports. This roster analysis may be Conference, School, or Team Based. The tool is used for assisting Sports Agents, Banks, Financial organizations as well as for Professional and Amateur athletes.

### Step 3:

IPC Inc. sends requests for proposals for all eligible athletes at the Institution to all Cover Holders who provide disability insurance for athletes (Wholesaler for Lloyds with specific contract policy language) for Maximum PTD and LoV limits.

### Step 4:

Cover Holders return proposals to IPC, Inc. with coverage limits for PTD and LoV as well as premium amounts/costs for coverage. Cover holders utilize Syndicate underwriters and actuaries and consultants to determine the value associated with the risk and eta bliss the threshold values The Cover holders sells and/or distributes policies and designs the contract rules that vary independent of each other and syndicates decide how much risk to acquire based upon risk tolerance. In the case of Group policies there may be a captive insurance company which takes on its own risk. In this case they would have to have cover holders that purchase the reinsurance risk. For example they may take on the first $500K of each claim and anything above that and the insurance company would have to cover the additional $4 Million. This described how aggregate risk vs. specific risk works in the insurance industry.

### Step 5:

IPC, Inc. collects proposals, contract offers and policy specimens and inputs the data into the “Professional Sports Draft Protector System” which in this instance is the tool that makes the necessary calculations. The data contains the Contract Specific Salary Index representative of the division of athletics or sport being analyzed. Each Athlete is independently entered into the system to determine maximum insurable value as well as maximum claims value.

### Step 6:

The calculations for an Average Draft Expectation is determined and eventually Lost Income Consequence Selection is determined for each position in Draft.

Given the Contract Salary Matrix, Unique Thresholds, Assigned LVTs, Projected Payment Calculations, Future Value Contract Benefits, and Minimum Estimated Slot Value the relevant question for the draft prospect, family members and athletics departments is which product represents the potential highest loss of value payout. In this example each Coverholder has the exact same Loss of Value benefit amount proposed, however the payouts vary greatly among the three coverholders/insurers. One would assume that if a proposed benefit states a coverage amount of $4,000,000 in the event of a Loss of Value claim that each policy would pay the full amount stated in the policy of $4,000,000.

However, this is seldom the case. Risk of loss regarding Loss of Value Contracts is misleading to the consumers of such products. Options which are provided and clarified by the tool(s) of the present disclosure include;
How does the draft prospect know exactly how much of a payment they can expect from such a loss?
How do the athletics departments know how to advise the draft prospect of differences in payouts?
How does the Draft Prospect's Sports Agent differentiate between a policy which states that it will pay out $4,000,000 from a policy which will actually pay the benefit stated amount?
How does a draft prospect calculate what benefit amount will be paid and which Loss of Value Contract is the best for their specific situation?
How should a professional sports team make an assessment as to the right amount of Loss of Value to present to their players?

Providing an objective and data based set of options to these issues have not heretofore been quantifiable in Coverholder/broker/Draft Prospect/Athletics Departments/Sports Agents/Professional Sports Teams interactions. In the present disclosure we provide clear identifiable options. The tool predicts with precision the trigger point at which the prospect (professional—and in many cases professional athlete) will begin receiving Loss of Value Payments. Here, one contract may begin paying at slot value #32 while another may begin paying at slot value #38, and another at slot value #60. It is a fact that as the calculations progress the LVPCs produce different PPCs for each MESV listed in the Contract Salary Matrix. Therefore the inconsistencies within the coverholder contracts with regard to identifiable risk associated with the specific draft prospect's PDSP and assigned LVT for each company are minimized or eliminated.

The present disclosure identifies the exact insertion point of Loss of Value with each specific Coverholder when specific variables are calculated. As the method clearly illustrates in Table V, this specific Draft Prospect would begin collecting a Loss of Value Claim at the CSI Position #38 from Coverholder #3 (CH3), provided that all necessary benefit triggers had been satisfied. As well, the method illustrates that no payment for Loss of Value is collectible for Coverholder #1 or #2 at this point on the Contract Salary Index. See Table VI.

TABLE VI

| CSI | | | 2107 Total | 2108 Total | LOV Benefit | LOV Benefit | LOV Benefit |
|---|---|---|---|---|---|---|---|
| Position/ | Contract | 2106 Total | MESV | MESV | Payable CH1 | Payable CH2 | Payable CH3 |
| Slot # | Years | FVCB | Projected | Projected | $4,000,000 | $4,000,000 | $4,000,000 |
| 32 | 4 | $6,609,641 | $6,804,625 | $7,005,362 | $0 | $0 | $1,794,638 |

The calculations equally provide the insertion point of claim payment for Coverholder #1 (CH1), as evidenced in Table VII. It is important to emphasize the difference calculated into the algorithm of Lost Income between CH3 and CH1 at CSI Position #32 carried throughout the CSI Matrix. This critically unique feature provides a comparison for the first time comparing the consequences of selecting one coverholder over any other without examining the Lost Income Consequence Selection (LICS). Table VIII demonstrates the consequence of selecting CH1 and CH2 over CH3 and the potential Loss of income due to this decision. Should the prospect have chosen CH1 or CH2 instead of CH3 and filed an eligible claim, falling to the 32nd position of the draft would have cost the prospect $1,794,638 due to the non-requirement of payment by CH1 and CH2 based on their assigned LVT's.

TABLE VII

| CSI | | | 2107 Total | 2108 Total | LOV Benefit | LOV Benefit | LOV Benefit |
|---|---|---|---|---|---|---|---|
| Position/ | Contract | 2106 Total | MESV | MESV | Payable CH1 | Payable CH2 | Payable CH3 |
| Slot # | Years | FVCB | Projected | Projected | $4,000,000 | $4,000,000 | $4,000,000 |
| 38 | 4 | $6,128,039 | $6,308,816 | $6,494,926 | $57,380 | $0 | $2,305,074 |

As described and calculated, should the decision to select CH1, or CH2 versus CH3, the Draft Prospect would suffer a Loss of income in the amount of $1,794,638, should the Draft Prospect fall from the projected draft position and trigger the assigned Threshold or Attachment Point from CH3. Should the Draft Prospect fall in draft position to trigger the payment for CH1, the method compares the Loss of Income associated with selecting CH1 over CH2, and CH3. Table VIII demonstrates the results.

TABLE VIII

| CSI | LOV Benefit | | | LOV Benefit | | | LOV Benefit | | |
|---|---|---|---|---|---|---|---|---|---|
| Position/ | Payable CH1 | LICS | LICS | Payable CH2 | LICS | LICS | Payable CH3 | LICS | LICS |
| Slot # | $4,000,000 | CH2 | CH3 | $4,000,000 | CH1 | CH3 | $4,000,000 | CH1 | CH2 |

| | | | | | |
|---|---|---|---|---|---|
| 32 | $0 | $0 | $1,794,638 | −$1,794,638 | −$1,794,638 |

Selecting CH1 over CH2 produces a positive number of $57,380, therefore should the Draft Prospect select CH1 over CH2 there would be no Lost Income Consequence Selection due to the positive number. However it is also clearly demonstrated that should the Draft Prospect select CH2 over CH1, the Lost Income Consequence Selection would equal −$2,247,694 in income lost simply by making the decision to choose CH2. Therefore, the method is quantitative and provides the losses in income with regard to decision making using limited knowledge and known variables. In some cases the system provides information to make a decision based upon only being shown one proposal for Loss of Value. In many instance the need for showing multiple options and creating the data for presentation in order to make a sound judgement is the norm.

Table IX Demonstrates the Lost Income Consequences (LICS) Selection for the insertion point of CH2 and compares the LICS for CH2 versus CH1 and CH3. Should the Draft Prospect choose CH2 over CH1, at the CSI Position 60, their LICS would be −$2,298,890 while only receiving a payment from CH2 for $3,416. Should the Draft Prospect choose CH2 over CH3, at the CSI Position 60, their LICS would be −$3,996,584 while only receiving a payment from CH2 for $3,416.

TABLE IX

| CSI | LOV Benefit | | | LOV Benefit | | | LOV Benefit | | |
|---|---|---|---|---|---|---|---|---|---|
| Position/ | Payable CH1 | LICS | LICS | Payable CH2 | LICS | LICS | Payable CH3 | LICS | LICS |
| Slot # | $4,000,000 | CH2 | CH3 | $4,000,000 | CH1 | CH3 | $4,000,000 | CH1 | CH2 |
| 60 | $2,305,722 | $2,302,306 | −$1,694,278 | $3,416 | −$2,298,890 | −$3,996,584 | $4,000,000 | −$1,694,278 | −$3,996,584 |

This also projects the contractual payment for the Draft Prospect in the event the athlete is not drafted and signs as a Free Agent. Table X indicates how this is determined using the required calculations.

The process addresses a problematic and common situation within collegiate professional draft prospects, their families, collegiate coaches, athletics compliance departments, and NCAA Institutions, Professional Sports Agents and Professional Sports Teams. These include;

TABLE X
Free Agent Payment Projections

| | | | LOV | LOV | LOV |
|---|---|---|---|---|---|
| | | | Benefit | Benefit | Benefit |
| | | | Payable: CH1 | Payable: CH2 | Payable: CH3 |
| | | | $4,000,000 | $4,000,000 | $4,000,000 |
| | | | Benefit*; | Benefit*; | Benefit*; |
| | | Contract | $6,552,306 | $4,250,000 | $8,800,000 |
| | Year: | Value: | Threshold | Threshold | Threshold |
| Free Agent | 1 | $540,000 | $1,098,076 | $272,500 | $1,660,000 |
| Rookie | 2 | $1,080,000 | $2,196,153 | $545,000 | $3,320,000 |
| Contract: | 3 | $1,620,000 | $3,294,230 | $817,500 | $4,000,000 |

How do these individuals and organizations make a decision as to how much Loss of Value coverage to purchase or how much Permanent and Total Disability Coverage to purchase? How can these individuals make a determination as to how much income would be lost in the event of an illness or injury associated with a drop in draft position due to the illness or injury event? Insurance companies and Brokers are willing to oversell the prospects and their families for amounts which will never pay out.
How does a family make a decision as to the amount of loss of earnings insurance to purchase for their son or daughter getting ready to enter the professional ranks? The process addresses these issues and provides a systematic approach for determining how much loss of income protection to purchase relative to a projected draft position for a collegiate athlete and the individuals assisting with the decision process including family members, NCAA Member Institutions, financial advisors and sports agents.

The present disclosure offers a unique quantitative approach to these needs by utilizing a historical professional draft ranking system and applying future increases in each draft position to determine a projected “Slot Value” for each position in each professional draft. By assigning and comparing these values to the “threshold value” assigned by the Coverholder, the present disclosure generates a level of income expectation from the draft position as well as generating an “expected claim” amount from the insurance policy/company.

By utilizing information provided herein precise determination of potential income is generated for each athlete entering their respective professional draft. This process also calculates the lost income and the specific benefit payable from an insurance policy with regard to a collegiate athlete being drafted at a later pick/round due to an illness or injury.

While the present disclosure has been described with reference to specific embodiments thereof, it will be understood that numerous variations, modifications and additional embodiments are possible, and all such variations, modifications, and embodiments are to be regarded as being within the spirit and scope of the invention.

Other embodiments of this aspect include corresponding computer systems, apparatus, and computer programs recorded on one or more computer storage devices, each configured to perform the actions of the methods.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more embodiments of the invention are set forth in the accompanying drawings and the description below. Other features, objects, and advantages of the invention will be apparent from the description and drawings, and from the claims.

The apparatus comprising the tool and associated devices of the present disclosure and associated invention can be implemented in a computer program product tangibly embodied or stored in a machine-readable storage device for execution by a programmable processor; and method actions can be performed by a programmable processor executing a program of instructions to perform functions of the invention by operating on input data and generating output.

The disclosure and associated invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

Other embodiments are within the scope and spirit of the description claims. Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the present application is not limiting but includes examples of how the techniques described herein may be implemented.

A number of embodiments of the invention have been described. Nevertheless, it will be understood that various modifications may be made without departing from the spirit and scope of the invention.

I claim:

1. A tool comprising utilization of one or more devices for completion of multiple calculations that determine and compare dynamically changing maximum insurance policy liability payouts, wherein said payouts change in value for one or more contractual compensation(s) for a professional individual and wherein said change in value of said payouts is a dynamic threshold value minus a dynamic contract value wherein said dynamic threshold value is utilized by one or more syndicates within one or more insurance companies to determine and ensure that a selected insurance policy covers a loss of payout that is less than said dynamic threshold value but greater than zero after said contract is completed by said professional individual.

2. The tool of claim 1, wherein said professional individual is any one of a group consisting of; an amateur or professional athlete, a fireman, policeman, corporate employee, physician, engineer, construction worker, mail carrier, city or county civil employee, university administrator, athletics director, coach, people who drive or ride in vehicles, boats, aircraft, and sports agent and wherein said contract is considered complete and valid after said contract is signed and dated.

3. The tool of claim 1, wherein said calculations are performed and displayed via visual, auditory, and/or visual/auditory techniques such that said tool resides one or more computers and/or computer platforms selected from a group consisting of: a networked computer system, a networked cloud-based computer system, one or more internet and/or intranet systems, computer laptops, computer pads, computer terminals, smart phones, and wearable computer devices and wherein said contractual compensation(s) are provided for one or more professional athlete's contracts.

4. The tool of claim 3, wherein said tool also provides a payout value after an athlete triggers a valid claim via injury, illness, or other disability that impairs an ability of said athlete to perform according to a contract's policy claims and definitions.

5. The tool of claim 1, wherein said threshold value is a value that triggers a claim based upon analysis of a compensatory contract's policies wherein when contract language is satisfied a value of a contract is less than said threshold value, wherein said calculations include comparison of threshold values and salary contract guarantees associated with either a position in a draft and/or a contract offer.

6. The tool of claim 1, wherein analysis of said calculations compares different policy benefits to determine different payout values for one or more insurance policies and wherein said analysis of said calculations compare different policy benefit definitions, triggers, and exclusions, in order to ascertain likelihood of a claim payment and wherein said calculations include risk analysis calculations and assigns a risk value for each payout based upon policy provisions, definitions, and exclusions.

7. The tool of claim 1, wherein said calculations compare values from each salary from each athlete that performs in one or more sports to arrive at a largest potential payout among a series of insurance policies.

8. The tool of claim 1, wherein said calculations provide one or more future projected values for each slot position in a professional athlete draft.

9. The tool of claim 1, wherein a threshold value is a value assigned and specific to an insured professional or professional prospect based upon a number that one or more insurance companies determine is a risk adjusted earnings potential for said professional.

10. The tool of claim 1, wherein cover holders/insurers utilize actuaries and underwriters to establish threshold values wherein said threshold values are at least partially determined based upon specific physical risks and certain projections provide contract payouts associated with said professional.

11. The tool of claim 1, wherein said insurance policies are futures contracts with changing dynamic premiums determined via said calculations regarding payout based upon predetermined threshold values less a signed contract value and any change in physical ability or health of said professional.

12. The tool of claim 1, wherein one or more syndicates utilize one or more threshold values to provide values for one or more compensatory contracts.

13. The tool of claim 1, wherein underwriters and/or syndicate actuaries determine risks for said policies, thresholds, and compensatory contracts.

14. The tool of claim 1, wherein said coverholders/insurers design contract language and provide risk options associated with said contract language to said syndicates in order that said syndicates can determine a specific degree of risk their investors are willing to ascertain.

15. The tool of claim 1, wherein said coverholders/insurers sell insurance policies and design contract rules that vary among coverholders/insurers such that an insurance policy offer is different for each professional and said calculations determine how much each insurance policy pays out when one or more insurance policy terms are satisfied and wherein said coverholders/insurers and brokers sell policies to said professionals, professional sport teams, athletic departments, and/or student athletes.

16. The tool of claim 1, wherein said loss of compensation value is a payment of a claim calculated as a difference between said threshold value and a signed, completed and/or earned contract value.

17. The tool of claim 1, wherein for an athlete, as a drop in draft position occurs, composition contract value drops but insurance policy coverage value increases to a maximum amount of stated liability and wherein said maximum amount of stated liability is a calculated value calculated by said tool that is reflected or stated within insurance policies.

18. The tool of claim 17, wherein said loss of value is a reduction in draft position and/or value of said contract.

19. The tool of claim 1, wherein loss of value of income to an athlete is calculated as a difference between threshold value and actual signed contract value and can be a loss of a rider value depending on a base disability policy if and only if a calculated difference between a threshold value and a contract value is a positive number.

20. The tool of claim 1, wherein a final draft position and/or contract value at least partially determines a cost and value of a disability insurance policy based upon a result from accidental bodily injury and/or illness.

21. The tool of claim 1, wherein a temporary disability of an athlete causes a drop in said draft position and/or compensatory contract value.

22. The tool of claim 21, wherein permanent disability is defined as inability for an athlete to continue to play in a professional sport due to injury and/or illness including trauma to a head of an athlete and/or said athlete is disabled to an extent where said athlete is no longer able to perform according to expectations of said compensatory contract and wherein a compensatory contract protection insurance policy can be linked to a disability policy for said professional.

23. The tool of claim 1, wherein a final compensatory contract offer is differentiated from a signed compensatory contract offer as both offers are seldom identical.

24. A system for evaluating and calculating potential losses incurred in actual or contractual income for current collegiate potential draft candidates/prospects and current professional athletes who own or consider owning draft protection insurance (Loss of Value) within the NFL, NBA, WNBA, NHL, MLS, WSL, and MLB comprising either sequential or non-sequential steps of:
a) selecting a professional sport in which a collegiate athlete participates and utilizing a Contract Salary Index (CSI) to examine ranges of salary expected for each slot value in a corresponding professional related athletics draft or renewal contract based on salaries and/or bonuses categorized on a per sport, position, and/or team basis.
b) utilizing one or more insurance contracts which insure loss of earnings due to an illness or injury and assigning a threshold value for each contract;
c) selecting a current salary scale for a professional sport;
d) projecting a future value of salary increase for said professional sport and athlete participating in said professional sport;
e) using a Contract Salary Index to compare potential payouts incurred due to an illness or injury preventing said athlete to further participate in a selected sport;
and/or;
f) using said Contract Salary Index to compare potential payouts incurred due to an illness or injury which results in a financial loss due to a drop in draft position and/or valid contract value.

25. The system of claim 24, further comprising selecting multiple permanent and total disability insurance policy products and loss of value/contract insurance riders, calculating a projected loss for each proposed insurance contract, and using projected loss indices to compare each alternative insurance product(s) to determine payout levels for each insurance contract.

26. The system of claim 25, wherein a Threshold Value or Attachment Point is assigned by each insurance provider.

27. The system of claim 25, wherein said Contract Salary Index is calculated from a combination of draft contract salaries including current and/or projected salaries for each draft slot position for each professional sport and wherein said Contract Salary Index contains an identifiable number which corresponds with a value for each draft slot based on historical professional drafts and wherein said Contract Salary Index is increased based upon historical increases and current cost of living adjustments to achieve a projected number for each draft position for at least three previous years.

28. The system of claim 25, wherein calculating a potential claim payment is derived by subtracting said Threshold Value and/or Attachment Point from a Projected Value in said Contract Salary Index for each specific slot value within each respective sport and wherein said system includes insurance policies comprising a plurality of policy attributes and assigns a rating system for each attribute.

29. The system of claim 25, wherein a range of projected payments based on an assigned claim value for each insurance policy from a first pick in a professional athlete draft to a last pick in said professional athlete draft is determined and identified and further comprising a potential claim payment for said athlete resulting in said athlete not being drafted as a result of illness and/or injury sustained during a defined insurance policy period and wherein a projected claim amount is calculated for an undrafted free agent based on a signing bonus and a signed free agent agreement with an associated actual number of years wherein said system provides a further assessment of contractual provisions to identify an insurance policy claim as a Permanent and Total Disability claim or a Loss of Value and/or contract claim and wherein said system calculates a Lost Income Consequence based on choosing an objective or subjective loss of contract value versus that of another loss of contract value wherein both contracts have equal or greater benefits.

30. One or more devices for completion of multiple calculations comprising; determination and comparison of dynamic maximum insurance policy liability payouts that change in value for one or more contractual compensation(s) for a professional individual wherein said change in value of said payouts is a dynamic threshold value minus a dynamic contract value wherein said threshold value is utilized by one or more syndicates within one or more insurance companies to ensure that a selected insurance policy covers a loss of payout that is less than said threshold value but greater than zero after said contract is completed and signed by said professional and wherein said devices allow for continuously changing payouts based on continuously changing dynamics on a continuous basis.
